(19) United States
(12) Patent Application Publication
(10) Pub. No.: US 2023/0235648 A1
(43) Pub. Date: Jul. 27, 2023

(54) COAL BED METHANE EXTRACTION AND UNDERGROUND CO2 STORAGE SYSTEM AND METHOD

(71) Applicant: EQT Corporation, Pittsburgh, PA (US)

(72) Inventors: Robert R. WINGO, Pittsburgh, PA (US); William E. JORDAN, Pittsburgh, PA (US); Toby Z. RICE, Pittsburgh, PA (US); Sarah FENTON, Pittsburgh, PA (US)

(73) Assignee: EQT Corporation, Pittsburgh, PA (US)

(21) Appl. No.: 18/159,147

(22) Filed: Jan. 25, 2023

Related U.S. Application Data
(60) Provisional application No. 63/303,280, filed on Jan. 26, 2022.

(51) Int. Cl. E21B 43/00; E21B 43/16; E21B 41/00; E21B 33/14; E21B 43/12

(52) U.S. Cl. CPC E21B 43/006; E21B 43/164; E21B 41/0064; E21B 33/14; E21B 43/121; E21B 33/1208

(57) ABSTRACT

A carbon-based gas extraction and storage system is described that includes a coal bed methane (CBM) energy production facility. A first well includes a first pump configured operate in an extraction mode in which methane from the CBM chamber is pumped from a CBM chamber, and convertible to an insertion mode in which CO2 is pumped into the CBM chamber. The second well extracts CBM from the CBM chamber. A controller controls the first pump to operate in the extraction mode and controllably switch to the insertion mode in which CO2 emissions from CBM processed by the CBM energy production facility are injected in the CBM chamber. Thus, first pump injects the CO2 emissions into the CBM chamber to assist in extraction of CBM and to permanently store the CO2 in the CBM chamber.

### CROSS-REFERENCE TO RELATED APPLICATION

The present application contains subject matter related to that disclosed in U.S. provisional patent application No. 63/303,280, filed in the USPTO on Jan. 26, 2022, the entire contents of which is incorporated herein by reference.

### FIELD OF THE DISCLOSURE

The present disclosure relates to a system and method of initially extracting underground coal-bed methane (CBM) and subsequently storing CO2 in its place.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Extraction wells are used to extract coalbed methane (CBM) CH4 from coalbeds and the CH4 can be used in the production of electricity, hydrogen, and/or sustainable aviation fuel (SAF). Injection wells can be used to enhance extraction of CH4 from a neighboring well of a common coalbed. Class VI certified wells are approved by the Environmental Protection Agency (EPA) for the safe geologic sequestration and permanent storage of CO2 in a CBM chamber within a coalbed.

### SUMMARY

According to aspects of the disclosed subject matter, a carbon-based gas extraction and CO2 (i.e., CO₂, carbon dioxide) storage system is described that includes a coalbed methane (CBM) energy production facility. A first well includes a first pump (submersible) configured operate in an extraction mode in which methane (CH4, also referred to as CH₄) from the CBM chamber is pumped from the CBM chamber. The first well is also convertible to operate in an insertion mode in which CO2 is injected into the CBM chamber for enhancing CH4 extraction and also CO2 geologic sequestration. The second well extracts CBM from the CBM chamber. A controller controls the first pump to operate in the extraction mode and controllably switches to operate a different pump to inject CO2 to the coalbed in the insertion mode. The CO2 may be a byproduct of a conversion process performed on the extracted CH4. A computer-based system allocates credits to users that elect to use CH4 converted into sustainable sources of energy such as H2 or aviation fuel.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a system diagram of a CBM extraction system in Phase 1, where a first well and a second well are both operated in CH4 extraction mode;

FIG. 2 is a system diagram of the CBM extraction system in Phase 2, during which the first well is operated in an injection mode to assist the second well's extraction of CH4 from the coalbed;

FIG. 3 is a system diagram of the CBM extraction system in Phase 3, during which a status of the first well operates as a Class VI well, approved for permanent CO2 geologic sequestration, in which the CO2 injected by the first well is permanently stored in the coalbed and continues to assist the second well's extraction of CH4 from the coalbed;

FIG. 4 is a flowchart of the three phases of the CBM extraction and CO2 injection system, as well as the system in continued operations of permanent CO2 geologic sequestration;

FIG. 5 is a flowchart of more specific steps performed during Phase 1;

FIG. 6 is a flowchart of more specific steps performed during Phase 2;

FIG. 7 is a flowchart of more specific steps performed during Phase 3;

FIG. 8 is a summary diagram of the three phases described in FIGS. 1-7;

FIG. 9 is a summary diagram showing how extracted CH4 and generated CO2 may be used for sustainable electrical power use by an end user, as well as for sustainable jet fuel production while geologically sequestering CO2 and using at least a portion of the generated CO2 for producing aviation fuel;

FIG. 10 illustrates a structure of a first well that may be used for extraction of CH4 and later switch to inject CO2 underground to the coalbed; and

FIG. 11 illustrates a structure of the first well that may be used for extraction of CH4 and later retrofitted to inject CO2 underground for permanent CO2 geologic sequestration.

FIG. 12 illustrates a system of wells formed along a coalbed according to one or more aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Referring now to the drawings, wherein like reference numerals designate identical or corresponding parts throughout the several views:

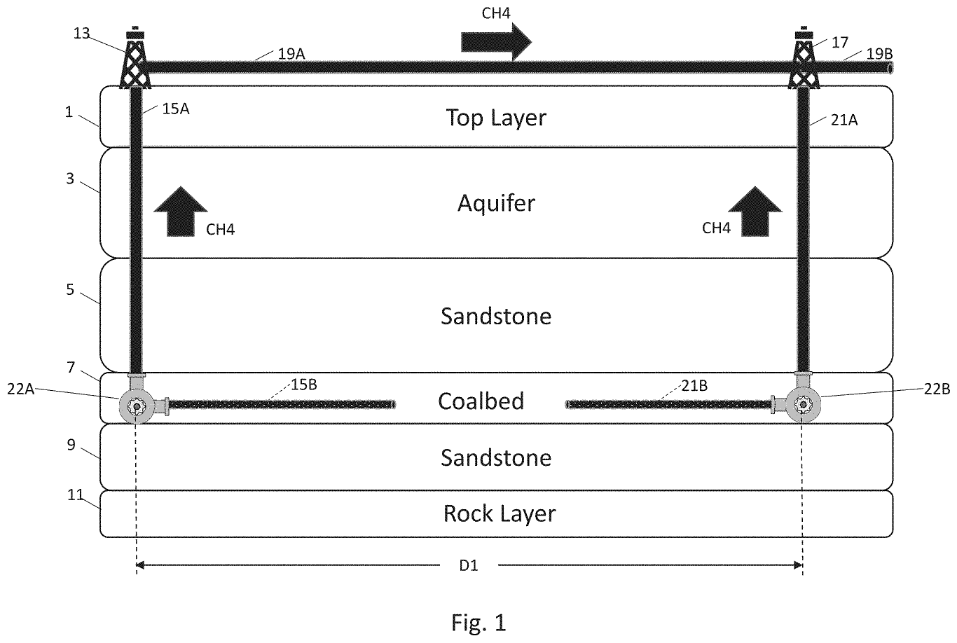

FIG. 1 illustrates a system diagram of a CBM extraction system in Phase 1, where two wells are operated to extract CH4 from an underground coalbed. As shown, a first well 13 and a second well 17 are separated by a distance D1 from one another (e.g., 100 m to 1 km) on the Earth's surface, over a series of geological layers that include a subterranean coalbed 7. Moreover, in this nonlimiting example, the coalbed 7 is sandwiched between two sandstone layers 5, 9, where the bottom sandstone layer 9 is positioned on top of a bedrock layer 11. The upper sandstone layer 5, in this example, underlies an aquifer 3, which is turn is beneath a top layer 1. These specific layers are only representative. Nevertheless, the coalbed 7 is a subterranean coal seam that includes trapped methane gas, CH4.

The first well 13 communicates gases via a vertical casing 15A from an optional horizontal well casing 15B that is positioned in the coalbed 7. Likewise, the second well 17 includes a vertical casing 21A to an optional horizontal well casing 21B that is positioned in the coalbed 7. The vertical wall casings 15A and 21A may be referred to herein as vertical wall conduits, vertical conduits, and/or well conduits. Submersible pumps 22A and 22B at the bottom of the first well 13 and the second well 17 pump fluid upward, which in turn draws CH4 from the coalbed 7 into the horizontal well casings 15B and 21B. In this example, the horizontal well casings 15B and 21B include perforations that allow the CH4 to be drawn into the horizontal well casings 15B and 21B through the perforations, as well as through open ends thereof. The CH4 that is drawn into the horizontal well casings 15B and 21B is conveyed to the first well 13 and second well 17 via the vertical well casings 15A and 21A respectively. This “upward” flow of CH4 is indicated by the upward pointed arrows in FIG. 1. CH4 from the first well 13 is shown to be conveyed toward the right in FIG. 1 (as shown by the arrow pointing right) via a first surface pipe segment 19A, and then once combined, CH4 from wells 13 and 17 is conveyed together via the second surface pipe segment 19B to a gas distribution system which ultimately is provided to end users.

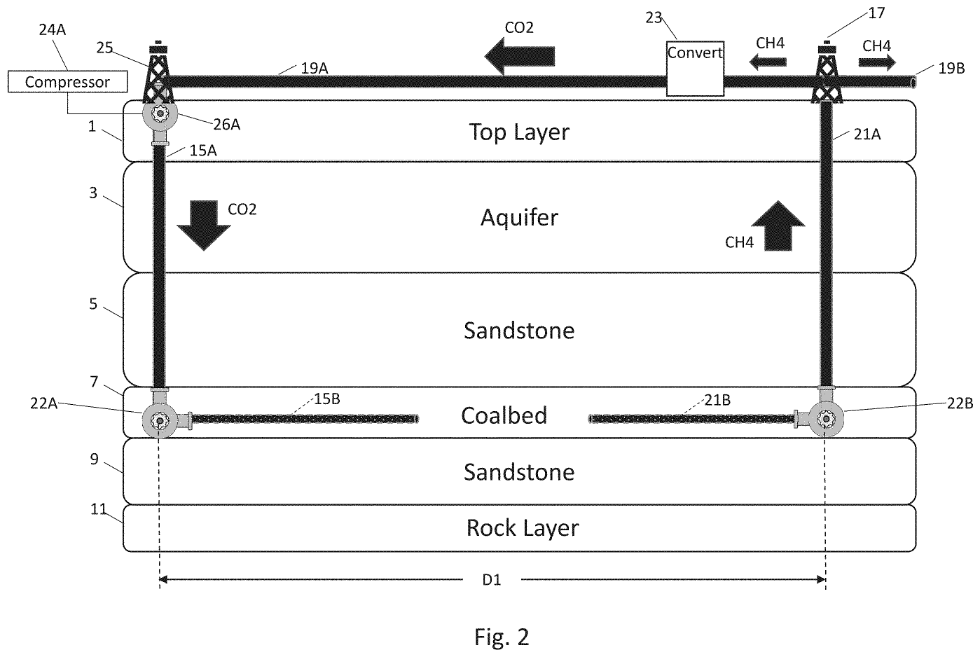

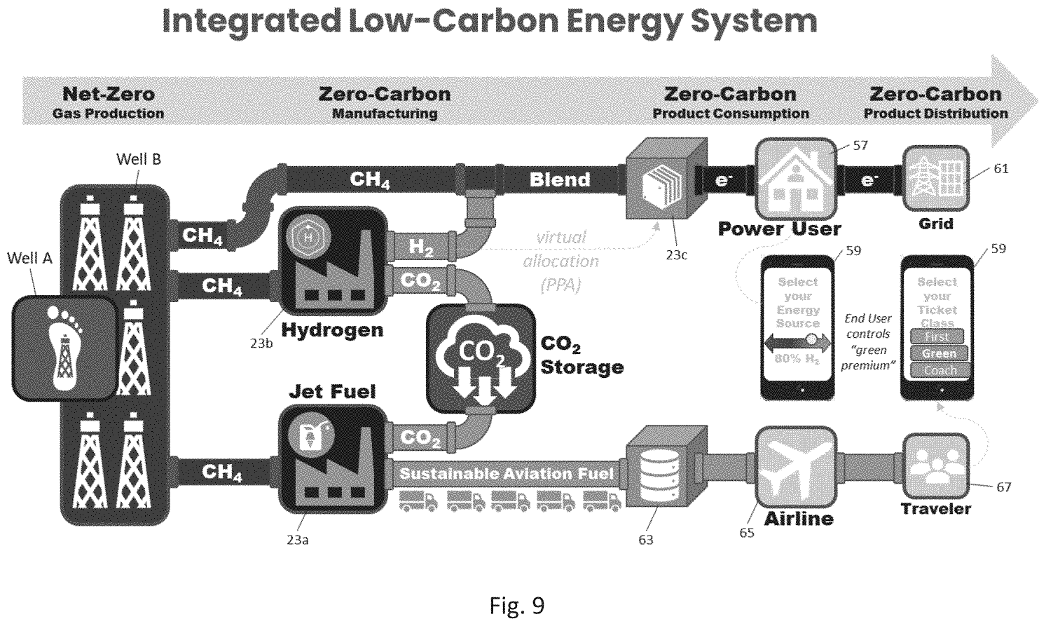

FIG. 2 is a system diagram of the CBM extraction system in Phase 2, where the first well 13 (as shown in FIG. 1) is switched to injection mode and thus shown as first well “25” in FIG. 2. In the injection mode, the first well 25 injects CO2, produced by a CH4 converter 23, into the coalbed 7 to assist the second well 17 extract CH4 from the coalbed 7. Moreover, as non-limiting examples, the CH4 converter may be a methane to Hydrogen converter like that shown in FIG. 9 or the Methane to aviation fuel converter shown in FIG. 9. The Hydrogen converter may take a variety of forms such as a steam-methane reformer in which high temperature steam (700-1000 degrees Celsius) is applied to CH4 under 3-25 bar in the presence of a catalyst to produce H2 and CO/CO2. Subsequently, in what is called the “water-gas shift reaction,” the carbon monoxide and steam are reacted using a catalyst to produce carbon dioxide and more hydrogen. In a final process step called “pressure-swing adsorption,” carbon dioxide and other impurities are removed from the gas stream, leaving essentially pure hydrogen. This two-step process may be summarized as

Step 1: Steam-methane reforming reaction CH₄+H₂O (+heat)→CO+3H₂
Step 2: Water-gas shift reaction CO+H₂O→CO₂+H₂ (+small amount of heat)

Partial Oxidation is another process that may be used for CH4 to H2 conversion. In partial oxidation, the methane and other hydrocarbons in natural gas react with a limited amount of oxygen (typically from air) that is not enough to completely oxidize the hydrocarbons to carbon dioxide and water. With less than the stoichiometric amount of oxygen available, the reaction products contain primarily hydrogen and carbon monoxide (and nitrogen, if the reaction is carried out with air rather than pure oxygen), and a relatively small amount of carbon dioxide and other compounds. Subsequently, in a water-gas shift reaction the carbon monoxide reacts with water to form carbon dioxide and more hydrogen. This two-step process may be summarized as follows:

Step 1: Partial oxidation of methane reaction: CH4+½O2→CO+2H2 (+heat)
Step 2: Water-gas shift reaction: CO+H2O→CO2+H2 (+small amount of heat)

One example of a CH4 to sustainable jet fuel (sustainable aviation fuel, SAF) process is called a Fischer-Tropsch process in which compressed steam reformed CH4 is combined with CO2 and supplied to a Fisher Tropsch Wax Cracking reactor before passing the gas through a heat exchanger and gas/liquid separator to produce the liquid jet fuel. The jet fuel distills at a temperature of between 150 degrees Celsius to 280 degrees Celsius. This process consumes CO2 to make a SAF.

Returning to FIG. 2, the CH4 converter 23 receives a portion of the CH4 extracted from the second well 17 and produces an output that includes CO2. The CO2 is provided to the first well 25 via surface pipe section 19A. Although in Phase 1 the surface pipe section 19A conveys CH4, the surface pipe section will convey CO2 in Phases 2 and 3. Because CO2 can be corrosive to steel, the surface pipe section is a cement lined pipe (a steel pipe that is lined with a cement mixture of mortar) to prevent the surface pipe 19A from corroding later in Phases 2 and 3 when it carries CO2.

The first well 25 operates in an injection mode. The first well 25 includes a compressor that compresses the CO2 and injects the CO2 down the vertical wall casing 15A to the horizontal wall casing 15B which is disposed in the coalbed 7. Once in the coalbed 7, the CO2 expands and displaces the resident CH4 disposed in the coalbed 7, and thus urges the CH4 into the horizontal well casing 21B that is communicatively connected to the second well 17 via the vertical well casing 21A. Moreover, the negative pressure provided by the pumping action of the second submersible pump 22B at the bottom of the second well 17, in combination with the positive pressure on the CH4 applied by the injected CO2 enhances the movement of CH4 into the horizontal well casing 21B, and thus enhances the extraction of the CH4 from the coalbed 7 by the second well 17.

In an alternative embodiment, the first well 25 may by a Class II well (enhanced gas recovery). Class II may be used since the coal is a hydrocarbon reservoir previously degassed and dewatered and this CO2 injection would be sequestering CO2 and enhancing Methane production.

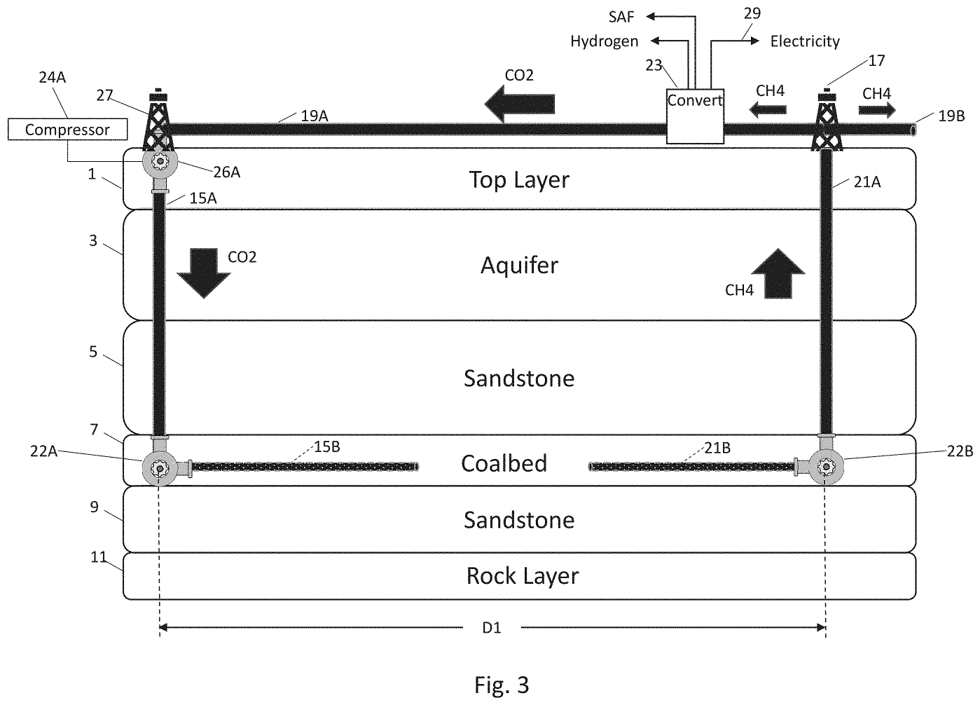

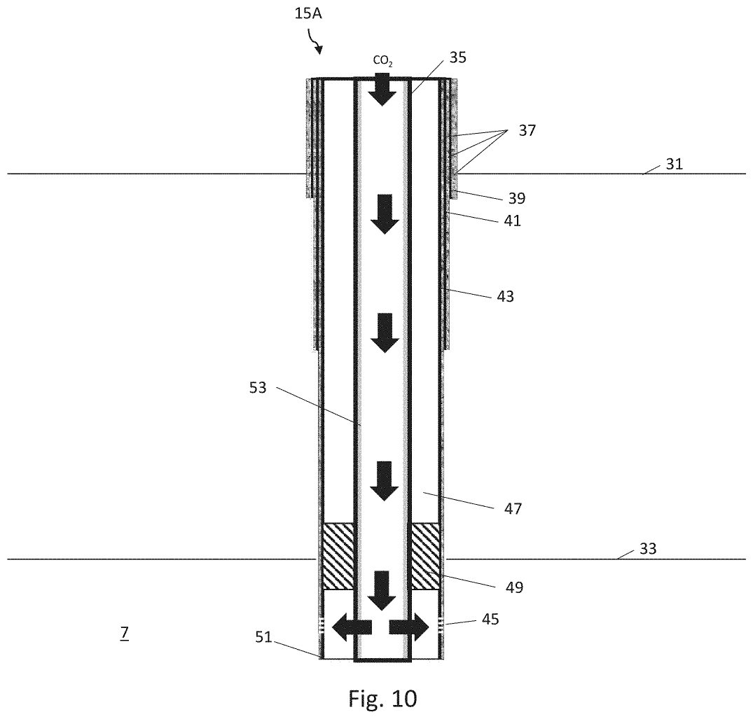

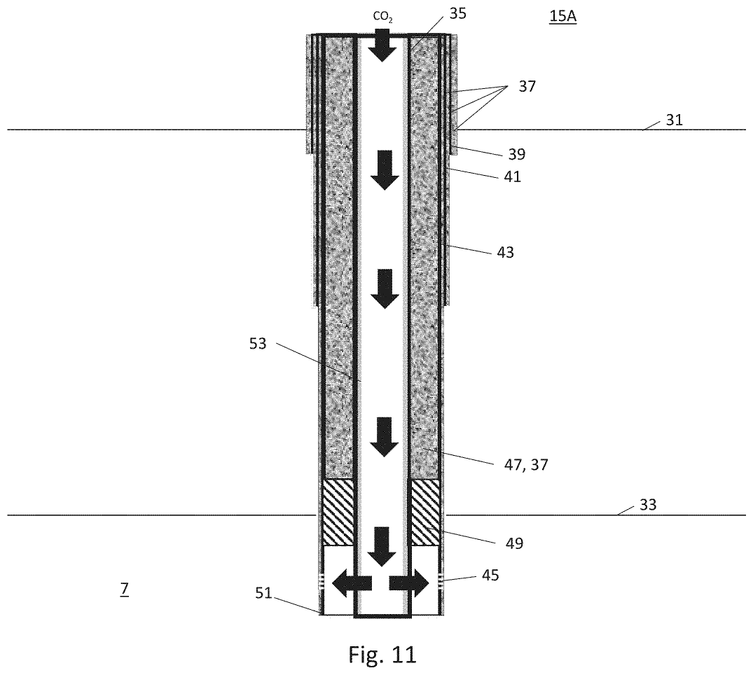

FIG. 3 is a system diagram of the CBM extraction system in Phase 3, where the status of the first well is approved as a Class VI well. As will be discussed in more detail with respect to FIGS. 10 and 11, Class VI well operations have strict structural requirements, and so the vertical wall casing 15A is initially constructed to support a rapid conversion to a Class VI well. In Phase 3, CO2 injected by the first well 27 into the coalbed 7 is for permanent storage of the CO2. FIG. 3 differs from FIG. 2 in several significant ways. Importantly, the first well 27 (previously 13 in FIGS. 1, and 25 in FIG. 2) has a Class VI status. Class VI wells, which are classified by the US Environmental Protection Agency, are used to inject carbon dioxide (CO2) into deep rock formations. This long-term underground storage is called geologic sequestration (GS). Geologic sequestration refers to technologies to reduce CO2 emissions to the atmosphere and mitigate climate change.

As recognized by the present inventors, the Class VI well certification is a lengthy process, often taking 5 years or more. Part of the approval process is comprehensive monitoring of CO2 injection and storage, as well as ground water inspection. However, rather than having a single well dedicated to CO2 injection, the present disclosure switches the operation of one of the wells from extraction to injection. From a system perspective, having both wells 13 and 17 operate in extraction during Phase 1 allows for rapid extraction during Phase 1. The production of CH4 during Phase 1 may be used for traditional energy production applications. However, by careful construction of the first well 13 and the surface pipe 19A, the existing infrastructure may be repurposed for more sustainable efforts to support end-users who may wish to exploit the benefits the CH4 converter 23 by producing electricity applied to an electrical line 29, and/or by H2 production, and/or aviation fuel production. Moreover, use of CO2 provided by the CH4 converter 23 may be captured and used for displacing CH4 in the coalbed 7 during Phase 2; however, simultaneous with Phase 2 operations, the application for converting the first well 13 into a Class VI well 27 may be submitted and thus “short cut” the process for geological sequestration of CO2 because some of the CO2 will remain trapped in the coalbed 7 during Phase 2. Thus, CO2 produced by the CH4 converter 23 in Phase 2 and Phase 3 is captured and permanently stored in the coalbed 7.

The present inventors recognized that the rate and volume of CO2 injected into the coalbed 7 during Phases 2 and 3 may be different. Thus, the first well 27 is equipped with a controllable compressor 24A and a variable rate pump 26A that variably adjusts the pressure at which CO2 is injected during Phase 2 so as to displace CH4 at a controlled rate without raising the pressures beyond the capability of the coalbed 7 to retain the CO2. Furthermore, although the first well 13 will initially be used in Phase 1 for extraction of CH4, it will ultimately be switched from extraction to insertion (for CO2 permanent storage). Thus, first well 13 is constructed (as will be discussed in more detail with respect to FIGS. 10 and 11) as an injection well that can largely be re-used to comply with Class VI requirements, which is suitable for injection of CO2 for permanent storage. The following paragraphs discuss structural differences between methane extraction wells, and an injection well that complies with Class VI requirements.

### Methane Extraction Well

Methane gas extraction wells are constructed by using a drill rig to install boreholes, typically at least 24 inches in diameter, into layers (layers 1, 3, and 5 in FIG. 1 for example) that overlay the methane coalbed 7 to allow for installation of a well screen and casing. The well structures may be a cased, cemented, perforated fracture stimulated completion or an open hold cavity completion. Both configurations are coaxial in structure with a central pipe attached to a water pump disposed at the bottom of the well which pumps water in the coalbed 7 to the surface. The water (or other fluids) is injected to release CH4 from the coal. Coal bed methane production is dependent on the reservoir pressure being reduced to permit methane to desorb from the coal. This requires water filling a cleat system to be removed, so a first step in producing CBM wells is to pump out the water. Around the pipe is a void (between the outer surface of the water pipe and inner surface of the casing) in which the CH4 flows to the surface and into the surface pipe segments 19A and 19B. A production casing is inserted along the borehole, within the inner circumference of the surface casing. The production casing is a steel pipe with a cement lining (also called a mild steel cement lined pipe, where the internal surface of the steel pipe is internally coated with a mortar like compound). A portion of the production casing disposed in the coalbed 7 is perforated so as to allow CH4 to permeate into a void between the central pipe and an inner surface of the production casing. An optional horizontal well casing 21B with perforations may be disposed in the coalbed 7.

In an openhole cavity configuration, an intermediate casing is disposed on an inner periphery of the surface casing, but the intermediate casing is not perforated and does not extend into the coalbed 7 by any appreciable amount. Extending from an inner surface of the intermediate casing is a perforated production liner that extends into the coalbed 7 and allows for CH4 to permeate into the void between the casings and the central pipe.

### Extraction/Insertion Well Structure

Class VI wells have different structural demands than extraction wells due mainly to higher injection rates and pressures for geologic sequestration (GS). Higher injection rates are also of concern because CO2 is less dense than most subsurface fluids and will tend to migrate to the top of an injection zone. A description of materials is provided below, and an arrangement of the structure is shown in FIGS. 10 and 11 and discussed later.

### Casing

An injection well has one or more successively smaller concentric pipes (essentially thick-walled pipes within pipes) placed in the well bore. All but the innermost pipe (called the tubing, or exchange tubing) serve as well casings. Leaks in the casing can allow fluid to escape into unintended zones or allow fluid movement between zones. Thus, the outermost material of the casing is cement that is used to support and seal the well casing to rock formations exposed in the borehole. Cement also protects the casing from corrosion and prevents movement of injectate up the borehole. The composition of the cement may contain latex, mineral blends, or epoxy. Cement additives may be used to ensure chemical compatibility, reduce cement loss, improve resistance to cyclic stress, or increase strength.

Carbon dioxide in combination with water forms carbonic acid, which is corrosive to many well components. Native fluids can also contain corrosive elements such as brines and hydrogen sulfide. Therefore, the casing is manufactured of materials that are compatible with fluids with which the casing might come into contact. The surface casing is the largest in diameter. It extends from the ground surface through the base of the lowermost portion of the underground sources of drinking water (USDW). This casing is emplaced and cemented into the bore hole from the base of the lowermost USDW up to the ground surface, serving to both prevent fluids from entering USDWs and prevent migration of fluids between USDWs and other formations, as the casing isolates the injection fluid. If the lowermost USDW is particularly deep, multiple strings of casing may be used as surface casing. Each string of casing is to be cemented to the surface. The smallest diameter casing extends into the injection zone and is referred to as the long-string casing. The long-string casing is routinely perforated in the injection zone to allow fluid to flow out of the injection well and into the injection formation. Spaces between the long-string casing and the surface casing, the long-string casing and the geologic formation, and the surface casing and the geologic formation are called annuli. These annuli are filled with cement in Class VI injection wells, along both the surface and the long-string casing. The long-string casing extends from the ground surface down to an injection zone. If the well is very deep, there may be one or more intermediate casings of intermediate diameter between the surface casing and the long-string casing. These casings are cemented in place as well.

### Tubing

The tubing (or exchange tube) is a smaller pipe which runs inside the long-string casing from the ground surface down to the injection zone. The CO2 (during injection) moves down the tubing, out through the perforations in the long-string casing, and into the injection zone. The tubing ends at a point just below a well packer 49. The space between the long-string casing and tubing is referred to as the annulus and is filled with a noncorrosive fluid. The tubing forms another barrier between the injected fluid and the long-string casing. The tubing and long-string casing act in concert to form two levels of protection between the carbon dioxide stream and the geologic formations above the injection zone.

### Cement

Cement is important for providing structural support of the casing, preventing contact of the casing with corrosive formation fluids, and preventing vertical movement of fluids and gases, including carbon dioxide. Down-hole pressures, fluids, and drilling mud can be managed when drilling so that down-hole conditions are suitable for well construction, cementing, and subsequent injection of carbon dioxide. Failing to cement the entire length of the casing, failure of the cement to bond with the casing or formation, not centralizing the casing during cementing, cracking, and alteration of the cement can all allow migration of fluids along the well bore. If carbon dioxide escapes the injection zone through the well bore because of a failed cement job, the well would be out of compliance with Class VI Rules and required to cease injection. CO2 can react with typical Portland cements commonly used in extraction well construction. As such, Class VI wells may be constructed using cements that are enhanced with additives that make the cement non-reactive to CO2, carbonated brine, and other corrosive fluids.

### Well Packer

A well packer 49 is a sealing device at the lower end of the tubing and keeps fluid from migrating from the injection zone into the annulus between the long-string casing and tubing. It must also be made of materials that are compatible with fluids with which it will come into contact, and thus are non-corrosive such as a nickel-plated assembly.

### Down Hole Stresses

A Class VI Rule requires the well be constructed to withstand anticipated stresses (e.g., 1500 to 3000 psi), to last the lifetime of the project, and to be compatible with fluids and materials that flow through the well. The cements are Portland based with various additives to alter cure time, strength, and sulfate resistance. American Petroleum Institute O, M, or H cements are used.

### Cementing the Casing

The surface casing must extend through the base of the lowermost USDW and be cemented to the surface through the use of single or multiple strings of casing and single or multiple stages of cement. A long-string casing extends at least to the injection zone and be cemented to the surface. The surface casing provides stability to the well bore by preventing unconsolidated soils and aggregates from falling into the borehole. It also typically decreases the amount of drilling mud used in the deeper portions of the well. By extending through the base of the lowermost USDW, the surface casing also seals off USDWs and other permeable zones from deeper intervals of the well bore. Thus, it provides an additional barrier to fluid or injectate migration into a USDW if the tubing and long-string casing should fail. Cementing of the long string casing serves to seal off the well bore and may prevent fluid or injectate leaks through the casing from entering a permeable zone, such as a USDW. If the cement was absent or improperly emplaced, and there was a tubing and casing failure, carbon dioxide could enter a permeable zone and then potentially migrate into USDWs through an annulus, or faults. Cementing the casing also protects it from exposure to carbonated brine and other corrosive fluids. Creation of a tight interface between the cement, casing, and the formation is the key to hydraulic isolation. Duguid and Crow, 2007, “CO₂ Well Integrity and Wellbore Monitoring” describes more detail about cementing, and the entire contents of this document is incorporated herein by reference. The well of FIGS. 10 and 11 used a centralizer to hold the casing in the center of the well bore during the cementing process. If centralizers are not used, the cement may end up being thinner (or even non-existent) on one side of the well bore, and the thinner portion will possibly be more susceptible to failure. Centralizer placement is especially important for the section of the injection well passing through the confining zone and into the injection interval. The Class VI Rule allows for cementing to be performed in one or more stages [40 CFR 146.86(b)(4)]. When switching a well from an extraction well to an insertion well, the well has cement injected down the well bore through a cement shoe and into the annulus. The cement is circulated until it reaches the surface and is then allowed to set.

### Two-Stage Cementing

Two-stage cementing is performed similarly to single stage cementing, except that a cement collar with cement ports is installed at an appropriate point in the well. The cement collar allows cement to be injected into the annulus between the casing and formation at some point in the column under construction other than the bottom of the well.

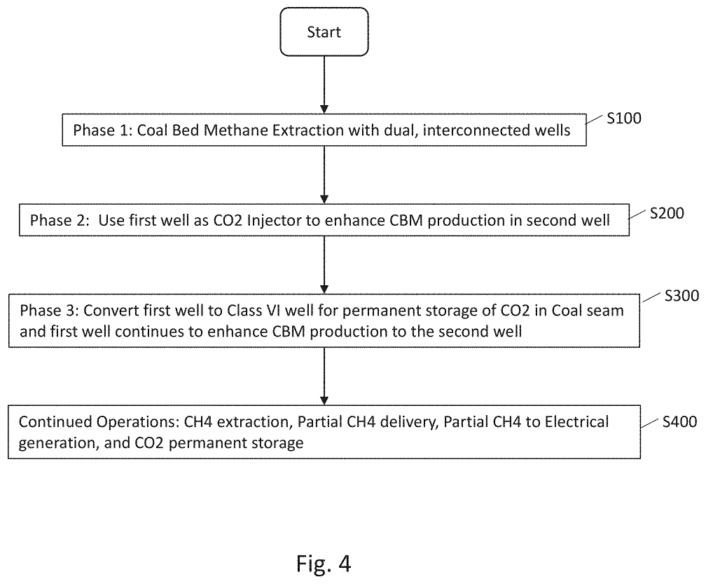

FIG. 4 is a flowchart of the three phases of the CBM extraction system and of continued operations of permanent CO2 storage in the coalbed 7. The process begins in step S100, where CBM extraction is performed with the first well 13 and the second well 17 extracting CH4 from the coalbed 7 (e.g., FIG. 1). The process then proceeds to step S200 where the first well 17 is converted to a CO2 injector (first well 17 renumbered to 25 in FIG. 2) to enhance CBM production in the second well 17 (e.g., FIG. 2). The process then proceeds to step S300 where the first well 25 granted Class VI status (first well 25 renumbered to 27 in FIG. 3) and the CO2 injected into the coalbed 7 is for enhanced extraction, but also for permanent underground storage (e.g., FIG. 3). The final step, S400, is for continued CO2 permanent storage.

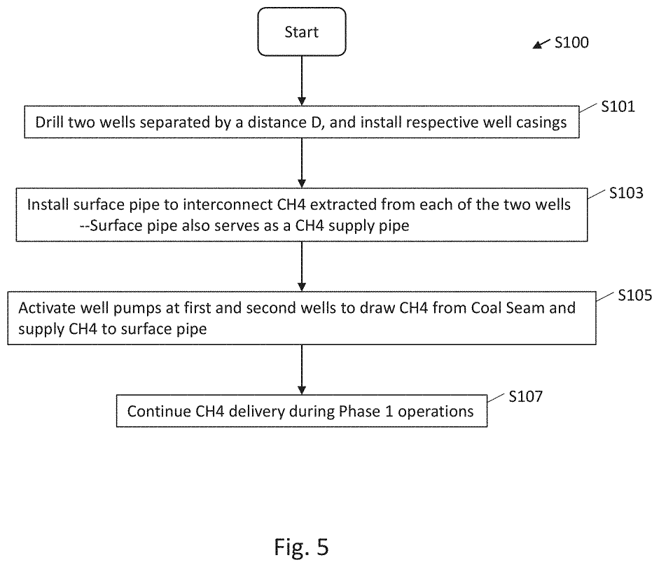

FIG. 5 is a flowchart of more specific steps performed during Phase 1, which are a part of S100. The process of step S100 begins in step S101 where two boreholes for wells are drilled at a separation distance D1 (e.g., 100 m to 300 m), and have respective well casings installed therein. However, any suitable distance may be used for the separation distance D1. According to some embodiments, the structure of the first well is built as a Class VI well (discussed later with respect to FIGS. 10 and 11), and the second well is built as an extraction well. In some embodiments, the first well 13 of FIG. 1 is built as a Class VI well but serves as an extraction well during Phase 1. In some embodiments, the second well 17 of FIG. 1 is built as a Class VI well but serves as an extraction well during Phase 1. The process proceeds to step S103 where a surface pipe segment 19A is installed between the two wells so that CH4 extracted from the coalbed may be inserted into the surface pipe segment 19A. Thus, the surface pipe segment 19A is used as a common collection pipe and surface pipe segment 19B is used as a supply pipe. The process then proceeds to step S105 where the two wells 13 and 17 are activated and draw CH4 from the coalbed 7 and supply the CH4 to the surface pipe segments 19A and 19B. The process continues in step S107 where CH4 continues to be extracted and delivered.

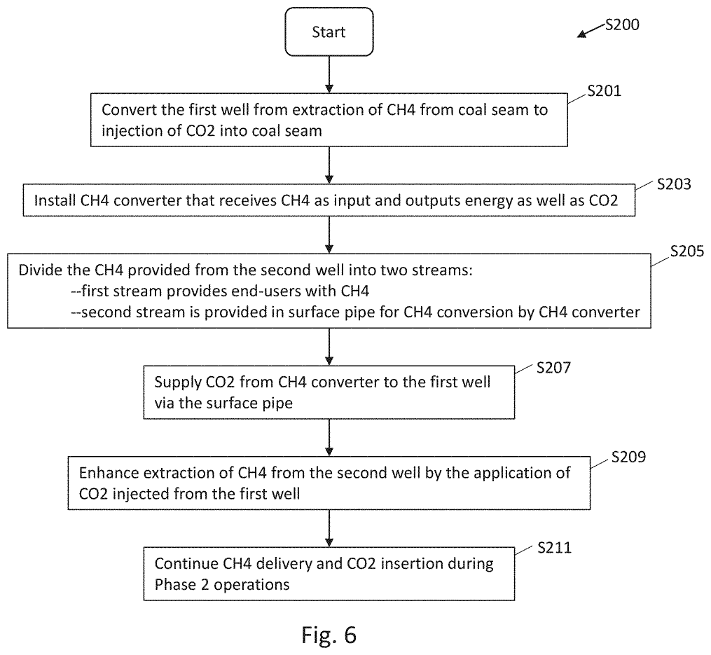

FIG. 6 is a flowchart of more specific steps performed during Phase 2, which are a part of S200. The process begins in step S201 where the first well 13 is converted from an extraction well to a CO2 injection well (25 of FIG. 2). The conversion of the first well 13 from an extraction well to a CO2 injection well comprises: installing the controllable compressor 24A and the variable rate pump 26A. The process then proceeds to step S203 where a CH4 converter 23 is inserted between the two wells and connected to the second well 17 on one side, and the first well 25 on the other side. Then in step S205 the second well 17 divides the CH4 into two streams: one for distribution to end-users via surface pipe segment 19B, and the other to feed the CH4 converter 23. In step S207 the CO2 converter performs a process on the CH4 that produces CO2 as a by-product. The CO2 produced by the CH4 converter 23 is provided to the first well 25 via the surface pipe segment 19A. As such, the directional flow of the CO2 during Phase 2 is opposite the direction of CH4 during Phase 1. The process then proceeds to step S209 where the CO2 injected by the controllable compressor 24A and variable rate pump 26A of the first well 25 into the coalbed 7 is used to enhance the extraction of CH4 from the coalbed 7. Finally in step S211 the use of CO2 to assist in the extraction of CH4 continues flowing via the first well 25 during Phase 2 operations.

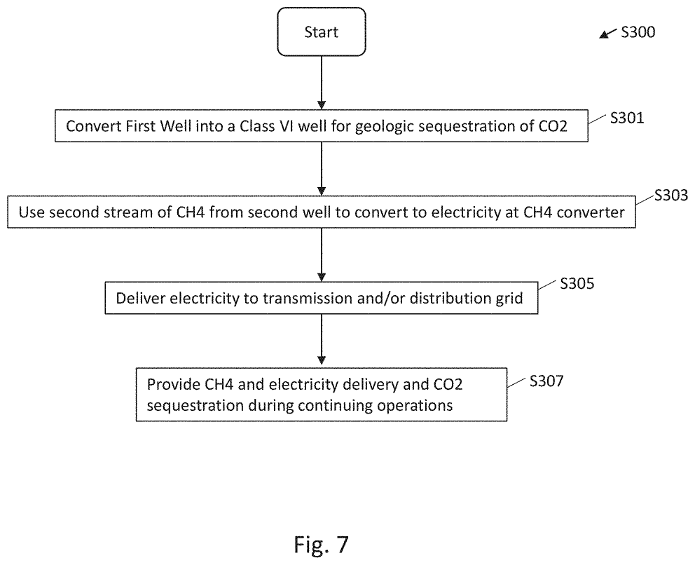

FIG. 7 is a flowchart of more specific steps performed during Phase 3, which are a part of S300. The process starts in Step S301 where the first well 27 (see FIG. 3) is approved for use as a Class VI well for CO2 geologic sequestration of CO2. In step S303 the second stream of CH4 from the second well 17 is applied to the CH4 converter 23 and converted to electricity, which is delivered to a transmission and/or distribution line 29 in step S305. In some embodiments, the second stream of CH4 from the second well 17 is applied to the converter 23 and is converted to hydrogen, GTL products, jet fuel (e.g., sustainable aviation fuel SAF), and/or other higher value products. The process of CO2 injection and sequestration using the first well 27 continues in step S307.

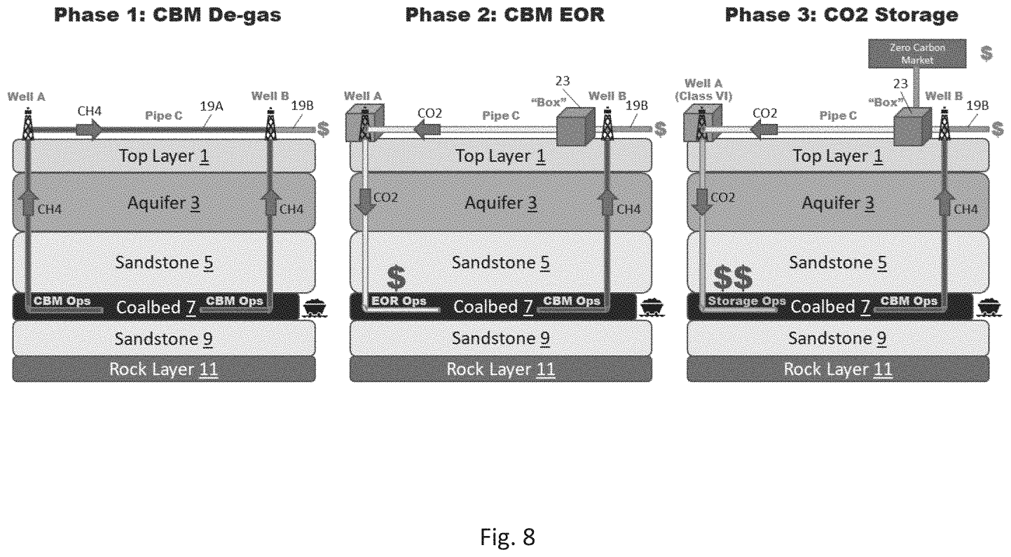

FIG. 8 is a summary diagram of the three phases described in FIGS. 1-7. As shown in FIG. 8 during Phase 1, both the first well (Well A) and the second well (Well B) cooperate to draw CBM from the coalbed 7 and into a common pipe C (e.g., first surface pipe segment 19A and second surface pipe segment 19B) for distribution to end users. In Phase 1, Coal Bed Methane (CBM) is developed ahead of mining operations for Well A and Well B. common pipe C is developed as a gas gathering line to market. Phase 1 operation may be referred to herein as CBM extraction operation, CBM Ops, CBM De-gas phase, and/or CBM De-gas Ops.

In Phase 2, converter box 23 is installed along the first surface pipe segment 19A. Converter box 23 is configured to convert CBM (e.g., methane CH4) to CO2/zero carbon product. Well A is converted to a CO2 injection well and the surface pipe (pipe C) is converted to a CO2 pipeline. The CO2 injection well (Well A) may also be referred to herein as a CO2 injector. Pipe C is converted into a CO2 pipeline. In some embodiments, the same pipe (pipe C) may be used in Phase 1 and Phase 2 provided the pipe is lined with a material (e.g., cement) to prevent CO2 from reacting with, and thus degrading over time, the pipe material (which in this example is steel). As such, the CO2 generated by the converter box 23 can be delivered to Well A over pipe C. By using a surface pump at Well A to inject compressed CO2 at a high pressure (e.g., above 500 psi), the pressure of the CO2 in the coalbed 7 displaces CH4 from the coalbed 7 and into the extraction well (Well B). Well B continues to operate in CBM extraction operations. The CH4 extracted from the coalbed 7 is divided at Well B with a controllable amount sent to the market via the second surface pipe segment 19B, and the remaining amount of CH4 feeds a process controlled by the converter box 23 that generates CO2 that is used for enhanced recovery operations by injection in Well A. Monetary, or carbon, credit is attributed to the entity that provides the CO2 via the CH4 conversion device (e.g., Converter Box 23 in FIG. 8). The credit is stored in a non-transitory computer readable medium so it may be retrieved later and attributed to the entity. For example, the credits may be generated by an entity during Phase 2 operations of the wells at a 45Q “EOR Rate” (e.g., $35/ton). Phase 2 operation may be referred to herein as enhanced CBM extraction, CBM EOR, and/or CBM enhanced oil recovery.

In Phase 3, Well A is approved for use as a Class VI well for permanent geologic sequestration of CO2 produced by the CH4 conversion device 23. Well A continues to inject CO2, generated by the converter box 23 and delivered via pipe C, into the coalbed 7 for permanent storage of the CO2 and for the enhanced CBM extraction of CH4 at Well B. During Phase 3 operation, zero carbon market products (e.g., hydrogen, gas-to-liquids, GTL, jet fuel, SAF, and/or the like) may be generated by the converter box 23. Further credits are provided to the entity for the CO2 that is stored permanently in the coalbed 7. For example, the additional credits may be generated by an entity during Phase 3 operations of the wells at a 45Q “Permanent Storage Rate” (e.g., $55/ton to $85/ton). Phase 3 operation may be referred to herein as CO2 storage, CO2 permanent storage, and/or CO2 storage operation. By following the phased approach summarized in FIG. 8, the process to achieve carbon capture utilization and storage (CCUS) and to generate zero carbon market products may be accelerated. The phased approach summarized in FIG. 8 may be referred to herein as carbon sequestration and zero carbon manufacturing of coal based methane.

FIG. 9 is a summary diagram showing how the extracted CH4 and CO2 storage may be used for sustainable electrical power used by an end user, as well as for sustainable jet fuel (e.g., sustainable aviation fuel (SAF)) production while geologically sequestering CO2 (CO2 storage). As shown in the upper portion of FIG. 9, CH4 that is extracted from Well B of the system shown in FIG. 8 is provided either directly to a CH4 converter box 23a, or blended with H2 though a hydrogen separation device converter box 23b as shown. The blend of CH4 and H2 is converted to electricity converter box 23c and applied to individually selectable end-users of zero-carbon residences 57 via a user device 59 (e.g., mobile phone, computer, or the like) and/or distribution on a power grid 61 (shared electrical distribution/transmission network). This process is described in more detail in U.S. provisional patent application No. 63/285,713, filed in the USPTO on Dec. 3, 2021, the entire contents of which is incorporated herein by reference.

However, a byproduct of H2 production from CH4 is CO2, which, as discussed in references to FIGS. 1-8, is stored in the coalbed 7. However, some or all of the CO2 produced from CH4 conversion (whether stored, or used on demand) is applied to a jet fuel converter box 23a, which was discussed above. The sustainable jet fuel (e.g., SAF) is delivered to a storage facility 63 and used for fueling an airplane of a zero-carbon airline 65. Passengers 67 (or commercial business purchasing seat, or cargo space on an airplane) can receive carbon credits for paying for seats/cargo-space on the airline 65 at a premium when they make a selection on a computer device 59 (e.g., mobile phone, computer, or the like). Moreover, those airline clients or passengers 67 are then entitled to a “carbon credit” for their purchasing of services on the airline 65). This operates in a same way as the electricity customers of zero-carbon residences 57 as discussed in U.S. provisional patent application No. 63/285,713. As an example, a user (e.g., passenger 67) who chooses to purchase a ticket on an airplane of the zero-carbon airline 65 that has been at least partially filled with sustainable fuel (e.g., SAF) generated by the jet fuel converter box 23a from some of the CO2 previously produced, will receive a credit for the use of that sustainable fuel. In this example, the user may select to purchase a “green” ticket as a seating option. The “green” ticket entitles that user to a certain amount of credit as a consequence of their purchase of a seat on a plane that is at least partially fueled with sustainable aviation fuel. This credit may take a variety of forms such as tax credit, monetary credit, or sustainability obligation that the individual or company committed to for personal or business reasons. Those credits are then stored in an accessible computer memory such as a semiconductor memory, or cloud storage (remote storage). The hardware platform (computer circuitry) for performing this algorithm is the same as that described in US provisional patent application No. 63/285,713, and thus is not reproduced herein.

Turning now to FIGS. 10 and 11 and with further reference to FIG. 8, well A is retrofitted from an extraction well during Phase 1 operation to an injection well during Phase 2 operation, and to an injection/sequestration well during Phase 3 operation, respectively. In particular, FIG. 10 is a diagram of the vertical wall casing 15A of Well A that operates as an injection well during Phase 2 for enhanced CBM extraction at Well B. FIG. 11 is a diagram of the vertical wall casing 15A of Well A that operates as an injection well during Phase 3 and is approved for use as a Class VI well for geologic sequestration of CO2.

Although Well A is initially used as an extraction well, it is easily configurable to support Class VI operations. Moreover, although an extraction well places a long string casing 43 in a borehole 51 and perhaps attaches at least a portion of the outer surface of the casing to the geologic material via concrete, the demands placed on an extraction well are much less than those placed on a Class VI injection well. Moreover, the extraction well normally only provides a water-based fluid that is pumped up through a central pipe (e.g., exchange tube 35) via a submersible pump 22A (see FIGS. 1-3) appended to the bottom of the exchange tube 35. CH4 gas permeates into a hollow annulus 47 that is present between the outer wall of the central exchange tube 35 and the inner wall of the long string casing 43, as is illustrated in FIG. 10. Strick confinement of the fluid or the CH4 (during Phase 1 extraction) is not nearly as critical for health and safety reasons as the confinement of CO2 gas that is injected at high volume and pressure into the coalbed 7 during Phase 3 operations. Thus, the well structure shown is FIG. 10 is suitable for containment of CO2 during injection operations, and is an excessive structure if it were used only for CH4 extraction.

As shown in FIG. 10, a borehole 51 extends from a top of the vertical well casing 15A through a base layer 31, and through a confinement layer 33 of the material in which the well is formed. During Phase 1, an exchange tube 35 is used for pumping fluid from the bottom thereof via a submersible pump 22A (see FIG. 1) to the surface. The exchange tube 35 includes an optional cement lining 53, which helps avoid corrosion of the steel tube material that comprises the exchange tube 35. The deepest portion of the borehole 51 (below the confining layer 33 but above the perforations 45) includes cement 37 that securely holds the long string casing 43 to the material in which the long string casing 43 is disposed. As previously discussed, this adherence of the long string casing 43 to the geologic material provides a seal to prevent CO2 from escaping along the surface of the borehole 51.

The perforations 45 at the bottom portion of the long string casing 43 communicate gases in and out of the borehole 51 and the coalbed 7. Thus during extraction, CH4 enters the long string casing 43 via the perforations 45, and during injection, the CO2 is emitted via the perforations 45.

At the upper end of the vertical well casing 15A, the outermost portion is a surface casing 39 having an outer surface cemented 37 to the surrounding geologic material. The surface casing 39 extends below the base layer 31. An intermediate casing 41 extends deeper, and it too is cemented 37 to geologic material around its outer periphery.

At the confining layer 33, for the conversion of the first well casing 15A from extraction operation during Phase 1 to injection operation during Phase 2, an injection well packer 49 is disposed about the exchange tube 35 to isolate an injection zone. In some embodiments, the injection well packer 49 is made from non-corrosive material (e.g., a nickel-plated steel). An annulus 47 may be filled with a non-corrosive fluid during Phase 1 extraction. However, during injection of CO2 (at least during Phase 3, and optionally during Phase 2) the annulus 47 is filled with cement 37 to firmly hold and seal the exchange tube 35 in place; see FIG. 11. The cement 37 filling the annulus 47 may be referred to herein as a cement injection plug, cement plug, and/or annulus plug. As such, the vertical well casing 15A may be modified after Phase 1 operation to a Class VI compliant vertical well casing 15A.

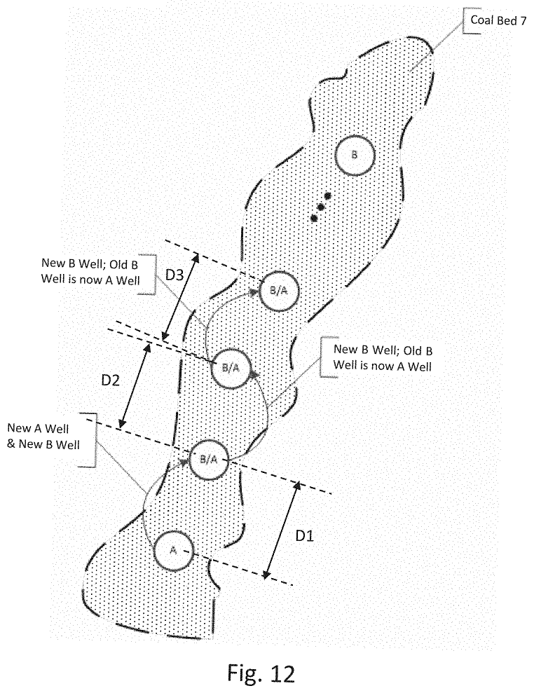

FIG. 12 illustrates a system of wells formed along the coalbed 7 according to one or more aspects of the disclosed subject matter. In particular, FIG. 12 illustrates a series of wells that cooperate in Well A and Well B pairs to progress through the three phases of operation as shown in FIG. 8. For example, starting at the bottom of FIG. 12, a new Well A and a new Well B may be established a first distance D1 apart and to operate in Phase 1 as extraction wells. Later, Well A may be converted to an injection well as described above and the Well A and Well B may operate in Phase 2 for the enhanced CBM extraction at Well B. Well A may be further converted to operate in Phase 3 as a Class VI injection well for the sequestration of CO2 in the coalbed 7 and for the enhanced CBM extraction at Well B. At a still later time, Well A may be capped by filling the exchange tube 35 with cement 37 for the permanent storage of CO2 in the coalbed 7.

In some embodiments, a new Well B may be formed a second distance D2 from the old Well B and operate in Phase 1 as an extraction well separate from the old Well B. In such embodiments, the old Well B may be converted at a later time to an injection well and operate as a new Well A in Phase 2 for the enhanced CBM extraction at new Well B. New Well A may be further converted to operate in Phase 3 as a Class VI injection well for the sequestration of CO2 in the coalbed 7 and for the enhanced CBM extraction at new Well B. At a still later time, new Well A may be capped by filling the exchange tube 35 with cement 37 for the permanent storage of CO2 in the coalbed 7. This process may continue along the coalbed 7 by adding a new Well B at a third distance D3 from the old Well B. The new Well B being constructed as an extraction well and the old Well B being converted to an injection well as a new Well A to assist in the extraction of at the new Well B. Although three pairs of Wells A and B are illustrated, any suitable number of wells may be utilized. Furthermore, the first distance D1, the second distance D2, and the third distance D3 may be different distances or they may be the same. The distances D1, D2, and D3 may be determined by the geology of the coalbed 7, the terrain at the surface of the wells, and/or the property rights of the land owners.

According to one or more aspects of the disclosed subject matter, a carbon-based gas extraction and storage system includes: a coal bed methane (CBM) energy production facility; a first well at a first location having a first pump and a first well conduit within a first borehole, the first well conduit extending from above ground to a subterranean coalbed methane (CBM) chamber, the first pump configured to operate in an extraction mode in which methane from the CBM chamber is pumped up from the CBM chamber, the first well being convertible to operate in insertion mode in which CO2 is injected into the CBM chamber for enhanced CH4 recovery and also for permanent CO2 geologic sequestration; a second well at a second location having a second pump and a second well conduit within a second borehole, the second well conduit extending from above ground to the subterranean coal bed methane chamber; an above-ground conduit that interconnects the first well conduit, the CBM energy production facility and the second well conduit; a controller configured to control the first pump to selectably operate in the extraction mode and provide CBM from the CBM chamber to the above-ground conduit, and configured to switch control of the first pump to a different pump that injects into the coalbed CO2 produced from CBM processed by the CBM energy production facility, wherein the different pump injects the CO2 emissions into the CBM chamber to assist in extraction of CBM by the second pump, and subsequently operates as a Class VI well that permanently stores the CO2 in the CBM chamber. In some embodiments, the first well conduit further includes an exchange tube including a cement lining. According to some aspects, the first well conduit further includes a string casing surrounding the exchange tube with an annulus disposed between sidewalls of the string casing and the exchange tube, wherein at least a portion of the outer surface of the string casing is attached to geologic material of the first bore hole via concrete. In one or more embodiments, the first well conduit further includes an intermediate casing surrounding the string casing and at least a portion of the outer surface of the string casing is attached to the intermediate casing via concrete. According to some aspects, the first well conduit further includes a surface casing surrounding the intermediate casing and at least a portion of the outer surface of the intermediate casing is attached to the surface casing via concrete. In accordance with some embodiments, at least a portion of the outer surface of the intermediate casing is attached to geologic material of the first bore hole via concrete, and at least a portion of the outer surface of the surface casing is attached to geologic material of the first bore hole via concrete. According to some embodiments, the carbon-based gas extraction and storage system further includes an injection packer disposed within the annulus above perforations in the string casing to prevent fluid from migrating from an injection zone of the first well into the annulus. In some embodiments, the injection packer includes a nickel-plated assembly. In accordance with some aspects of the carbon-based gas extraction and storage system, the system further includes a cement plug adjacent to the injection packer and filling the annulus. According to some embodiments, at least one of hydrogen and sustainable aviation fuel is produced from the CBM production facility.

In accordance with one or more aspects of the disclosed subject matter, a method of converting a well operable in an extraction mode to operate in insertion mode for enhanced CH4 recovery and also for permanent CO2 geologic sequestration, the method includes: forming a borehole from a first surface location to a subterranean coalbed methane (CBM) chamber; inserting a string casing in the borehole; cementing at least a portion of the string casing to geologic material of the borehole via concrete; inserting an exchange tube in the string casing such that a hollow annulus is formed between the outer sidewall of the exchange tube and the inner sidewall of the string casing; lining the inner sidewall of the exchange tube with a cement lining; operating a well pump in an extraction mode to pump CBM through the exchange tube from the CBM chamber to the first surface location; after operating the well pump in the extraction mode, inserting an injection packer in the annulus of the well; receiving a flow of CO2 from a surface pipe; and operating another well pump in an injection mode to inject the CO2 through the exchange tube and into the CBM chamber. In some embodiments, the method further includes forming a cement plug adjacent to the injection packer by filling the section of the annulus over the injection packer with the concrete. According to one or more embodiments, a composition of the concrete contains a cement additive including at least one of: latex, mineral blends, and epoxy. In accordance with one or more aspects of the method, the injection packer includes a nickel-plated assembly. In some embodiments, the method further includes inserting an intermediate casing in the borehole, wherein the intermediate casing surrounds the string casing; cementing at least a portion of the intermediate casing to geologic material of the borehole via concrete; and cementing at least another portion of the string casing to the intermediate casing via the concrete. According to one or more embodiments, the method further includes inserting a surface casing in the borehole, wherein the surface casing surrounds the intermediate casing; cementing at least a portion of the surface casing to geologic material of the borehole via concrete; and cementing at least another portion of the intermediate casing to the surface casing via the concrete.

In accordance with one or more aspects of the disclosed subject matter, a carbon-based gas extraction and storage well includes a well including a first pump and a well conduit within a borehole, the well conduit extending from above ground to a subterranean coalbed methane (CBM) chamber, the first pump being configured to operate in an extraction mode in which methane from the CBM chamber is pumped up from the CBM chamber, wherein the well is convertible to operate in insertion mode in which CO2 is injected into the CBM chamber for enhanced CH4 recovery and also for permanent CO2 geologic sequestration; and a controller configured to control the first pump to selectably operate in the extraction mode and provide CBM from the CBM chamber to the above-ground conduit, and configured to switch control of the first pump to a different pump that injects into the coalbed CO2 emissions produced from a CBM energy production facility, wherein the different pump injects the CO2 emissions into the CBM chamber to assist in extraction of CBM from the coalbed by another well, and subsequently operates as a Class VI well that permanently stores the CO2 in the CBM chamber. In some embodiments, the carbon-based gas extraction and storage well further includes an exchange tube including a cement lining; and a string casing surrounding the exchange tube such that a hollow annulus is disposed between the outer sidewall of the exchange tube and the inner sidewall of the string casing, wherein at least a portion of the string casing is attached to geologic material of the borehole via concrete. According to one or more embodiments, a composition of the concrete contains a cement additive including at least one of: latex, mineral blends, and epoxy. In some embodiments, the carbon-based gas extraction and storage well further includes an injection packer in the hollow annulus of the well to prevent leakage into the hollow annulus during injection of the CO2 emissions into the CBM chamber.

### DRAWING ELEMENTS

1, 3, 5, 9, 11: Geological Layers
7: Coalbed
13: First Well in Phase 1
15A, 21A: Vertical Well Casing
15B, 21B: Horizontal Well Casing
17: Second Well
19A, 19B: Surface Pipe Segments
23: CH4 Converter
25: First Well in Phase 2 (CO2 injection for assisting CH4 extraction)
27: First Well in Phase 3 as a Class VI well (CO2 permanent storage)
29: Electrical Line
31: Base Layer
33: Confining Layer
35: Exchange tube
37: Cement
39: Surface Casing
41: Intermediate Casing
43: Long String Casing
45: Perforations
47: Annulus containing non-corrosive fluid
49: Injection Packer
51: Borehole
53: Cement Lining (optional)

1. A carbon-based gas extraction and storage system comprising:
a coal bed methane (CBM) energy production facility;
a first well at a first location having a first pump and a first well conduit within a first borehole, the first well conduit extending from above ground to a subterranean coalbed methane (CBM) chamber, the first pump configured to operate in an extraction mode in which methane from the CBM chamber is pumped up from the CBM chamber, the first well being convertible to operate in insertion mode in which CO2 is injected into the CBM chamber for enhanced CH4 recovery and also for permanent CO2 geologic sequestration;
a second well at a second location having a second pump and a second well conduit within a second borehole, the second well conduit extending from above ground to the subterranean coal bed methane chamber;
an above-ground conduit that interconnects the first well conduit, the CBM energy production facility and the second well conduit;
a controller configured to
control the first pump to selectably operate in the extraction mode and provide CBM from the CBM chamber to the above-ground conduit, and
switch control of the first pump to a different pump that injects into the coalbed CO2 produced from CBM processed by the CBM energy production facility, wherein the different pump injects the CO2 emissions into the CBM chamber to assist in extraction of CBM by the second pump, and subsequently operates as a Class VI well that permanently stores the CO2 in the CBM chamber.

2. The carbon-based gas extraction and storage system of claim 1, wherein the first well conduit further comprises an exchange tube including a cement lining.

3. The carbon-based gas extraction and storage system of claim 1, wherein:
the first well conduit further comprises a string casing surrounding the exchange tube with an annulus disposed between sidewalls of the string casing and the exchange tube, and
at least a portion of the outer surface of the string casing is attached to geologic material of the first bore hole via concrete.

4. The carbon-based gas extraction and storage system of claim 3, wherein the first well conduit further comprises an intermediate casing surrounding the string casing and at least a portion of the outer surface of the string casing is attached to the intermediate casing via concrete.

5. The carbon-based gas extraction and storage system of claim 4, wherein the first well conduit further comprises a surface casing surrounding the intermediate casing and at least a portion of the outer surface of the intermediate casing is attached to the surface casing via concrete.

6. The carbon-based gas extraction and storage system of claim 5, wherein:
at least a portion of the outer surface of the intermediate casing is attached to geologic material of the first bore hole via concrete, and
at least a portion of the outer surface of the surface casing is attached to geologic material of the first bore hole via concrete.

7. The carbon-based gas extraction and storage system of claim 3, further comprising an injection packer disposed within the annulus above perforations in the string casing to prevent fluid from migrating from an injection zone of the first well into the annulus.

8. The carbon-based gas extraction and storage system of claim 7, wherein the injection packer comprises a nickel-plated assembly.

9. The carbon-based gas extraction and storage system of claim 7, further comprising a cement plug adjacent to the injection packer and filling the annulus.

10. The carbon-based gas extraction and storage system of claim 1, wherein at least one of hydrogen and sustainable aviation fuel is produced from the CBM production facility.

11. A method of converting a well operable in an extraction mode to operate in insertion mode for enhanced CH4 recovery and also for permanent CO2 geologic sequestration, the method comprising:
forming a borehole from a first surface location to a subterranean coalbed methane (CBM) chamber;
inserting a string casing in the borehole;
cementing at least a portion of the string casing to geologic material of the borehole via concrete;
inserting an exchange tube in the string casing such that a hollow annulus is formed between the outer sidewall of the exchange tube and the inner sidewall of the string casing;
lining the inner sidewall of the exchange tube with a cement lining;
operating a well pump in an extraction mode to pump CBM through the exchange tube from the CBM chamber to the first surface location;
after operating the well pump in the extraction mode, inserting an injection packer in the annulus of the well;
receiving a flow of CO2 from a surface pipe; and
operating another well pump in an injection mode to inject the CO2 through the exchange tube and into the CBM chamber.

12. The method of claim 11, further comprising:
forming a cement plug adjacent to the injection packer by filling the section of the annulus over the injection packer with the concrete.

13. The method of claim 11, wherein a composition of the concrete contains a cement additive including at least one of: latex, mineral blends, and epoxy.

14. The method of claim 11, wherein the injection packer comprises a nickel-plated assembly.

15. The method of claim 11, further comprising:
inserting an intermediate casing in the borehole, wherein the intermediate casing surrounds the string casing;
cementing at least a portion of the intermediate casing to geologic material of the borehole via concrete; and
cementing at least another portion of the string casing to the intermediate casing via the concrete.

16. The method of claim 15, further comprising:
inserting a surface casing in the borehole, wherein the surface casing surrounds the intermediate casing;
cementing at least a portion of the surface casing to geologic material of the borehole via concrete; and
cementing at least another portion of the intermediate casing to the surface casing via the concrete.

17. A carbon-based gas extraction and storage well comprising:
a well including a first pump and a well conduit within a borehole, the well conduit extending from above ground to a subterranean coalbed methane (CBM) chamber, the first pump configured to operate in an extraction mode in which methane from the CBM chamber is pumped up from the CBM chamber, wherein the well is convertible to operate in insertion mode in which CO2 is injected into the CBM chamber for enhanced CH4 recovery and also for permanent CO2 geologic sequestration; and
a controller configured to
control the first pump to selectably operate in the extraction mode and provide CBM from the CBM chamber to the above-ground conduit, and
switch control of the first pump to a different pump that injects into the coalbed CO2 emissions produced from a CBM energy production facility, wherein the different pump injects the CO2 emissions into the CBM chamber to assist in extraction of CBM from the coalbed by another well, and subsequently operates as a Class VI well that permanently stores the CO2 in the CBM chamber.

18. The carbon-based gas extraction and storage well of claim 17, further comprising:
an exchange tube including a cement lining; and
a string casing surrounding the exchange tube such that a hollow annulus is disposed between the outer sidewall of the exchange tube and the inner sidewall of the string casing, wherein at least a portion of the string casing is attached to geologic material of the borehole via concrete.

19. The carbon-based gas extraction and storage well of claim 18, wherein a composition of the concrete contains a cement additive including at least one of: latex, mineral blends, and epoxy.

20. The carbon-based gas extraction and storage well of claim 18, further comprises
an injection packer in the hollow annulus of the well to prevent leakage into the hollow annulus during injection of the CO2 emissions into the CBM chamber.
